(19) United States
(12) Patent Application Publication
(10) Pub. No.: US 2025/0043622 A1
(43) Pub. Date: Feb. 6, 2025

(54) FLEXIBLE LASER GLASS FILM STRUCTURE, GLASS AND WINDOW

(71) Applicant: Hui Chen, Shanghai (CN)

(72) Inventor: Hui Chen, Shanghai (CN)

(21) Appl. No.: 18/759,920

(22) Filed: Jun. 30, 2024

(30) Foreign Application Priority Data
Aug. 2, 2023 (CN) 2023220663308

(51) Int. Cl. E06B 9/24; B32B 7/06; B32B 17/10

(52) U.S. Cl. CPC E06B 9/24; B32B 7/06; B32B 17/10247; B32B 17/1044; B32B 2307/412; B32B 2307/584; B32B 2419/00; E06B 2009/2417

(57) ABSTRACT

Embodiments of the present disclosure disclose a flexible laser glass film structure, a glass and a window, and relate to the technical field of glass films. The flexible laser glass film structure includes a hardened scratch-resistant transparent layer, an ultraviolet- and infrared-resistant transparent layer, a laser film layer, a mounting adhesive layer and a release film layer that are connected to one another in sequence. The flexible laser glass film structure in the embodiments of the present disclosure can improve the ultraviolet- and infrared-resistant effect, reduce the degree of surface scratching and improve the visual effect.

### TECHNICAL FIELD

Embodiments of the present disclosure relate to the technical field of glass films, and in particular, to a flexible laser glass film structure, a glass and a window.

### BACKGROUND

In daily life, when people need sufficient light while needing to protect indoor privacy, window glass films are typically attached to window glass. The window glass films can provide an effect of blurring the window glass, prevent indoor situations from being observed from the outside through the window glass, and thus meet people's needs for protecting indoor privacy. In addition, compared with window curtains, the window glass films can allow more light to enter rooms, so as to meet people's needs.

### SUMMARY

In order to overcome the shortcomings of the prior art, embodiments of the present disclosure provide a flexible laser glass film structure, a glass and a window, which are intended to improve the ultraviolet- and infrared-resistant effect, reduce the degree of surface scratching and improve the visual effect.

The embodiments of the present disclosure are implemented by adopting the following technical solution.

In a first aspect, the embodiments of the present disclosure provide a flexible laser glass film structure, which includes a hardened scratch-resistant transparent layer, an ultraviolet- and infrared-resistant transparent layer, a laser film layer, a mounting adhesive layer and a release film layer that are connected to one another in sequence, wherein the hardened scratch-resistant transparent layer includes a first transparent substrate layer, an aluminum-plated layer and a hardened coating, the first transparent substrate layer being connected to the ultraviolet- and infrared-resistant transparent layer, the aluminum-plated layer being disposed on a surface of the first transparent substrate layer facing away from the ultraviolet- and infrared-resistant transparent layer, and the hardened coating being disposed on a surface of the aluminum-plated layer facing away from the first transparent substrate layer; and the laser film layer includes a second transparent substrate layer and a laser pattern layer, the second transparent substrate layer being connected to the mounting adhesive layer, and the laser pattern layer being disposed in an incompletely covering manner on a surface of the second transparent substrate layer facing away from the mounting adhesive layer.

In a second aspect, the embodiments of the present disclosure provide a glass, which includes a glass body and a flexible laser glass film structure as described above, the mounting adhesive layer being connected to the glass body after the release film layer is torn off from the flexible laser glass film structure.

In a third aspect, the embodiments of the present disclosure provide a window, which includes a window frame and a glass as described above, the glass being disposed on the window frame.

### BRIEF DESCRIPTION OF THE DRAWINGS

FIG. 1 is a schematic diagram of a flexible laser glass film structure according to one embodiment of the present disclosure;

FIG. 2 is a schematic structural diagram of a hardened scratch-resistant transparent layer according to one embodiment of the present disclosure;

FIG. 3 is a schematic structural diagram of a laser film layer according to one embodiment of the present disclosure;

FIG. 4 is a schematic diagram of a flexible laser glass film structure in an unrolled state according to one embodiment of the present disclosure;

FIG. 5 is a schematic diagram of a flexible laser glass film structure in an unrolled state according to another embodiment of the present disclosure;

FIG. 6 is a schematic diagram of a flexible laser glass film structure in a rolled state according to one embodiment of the present disclosure;

FIG. 7 is a schematic diagram of a flexible laser glass film structure in a rolled state according to another embodiment of the present disclosure; and

FIG. 8 is a schematic diagram of a flexible laser glass film structure in a rolled state according to still another embodiment of the present disclosure.

List of reference signs: 1. Hardened scratch-resistant transparent layer; 2. Ultraviolet- and infrared-resistant transparent layer; 3. Laser film layer; 4. Mounting adhesive layer; 5. Release film layer; 6. First transparent substrate layer; 7. Aluminum-plated layer; 8. Hardened coating; 9. Second transparent substrate layer; 10. Laser pattern layer.

### DESCRIPTION OF THE PREFERRED EMBODIMENTS

Specific embodiments of the present disclosure will be described in detail in this section. Preferred embodiments of the present disclosure are illustrated in the accompanying drawings. The accompanying drawings serve to supplement the text description of the specification with figures, providing a visual understanding of each technical feature and the overall technical solution of the embodiments of the present disclosure, but cannot be construed as a limitation to the scope of protection of the embodiments of the present disclosure.

In the description of the embodiments of the present disclosure, it should be understood that orientation or position relationships indicated by terms “upper”, “lower”, “front”, “rear”, “left”, “right”, etc. are orientation or position relationships as shown in the accompanying drawings, and these terms are just used to facilitate description of the embodiments of the present disclosure and simplify the description, rather than indicating or implying that the mentioned device or element must have a specific orientation and must be constructed and operated in a specific orientation, and thus cannot be construed as a limitation to the embodiments of the present disclosure.

In the description of the embodiments of the present disclosure, “several” means one or more, “a plurality of” means two or more, “greater than”, “less than”, “over”, etc. are construed as excluding the number, and “above”, “below”, “within”, etc. are construed as including the number. The terms “first” and “second” in the description are merely intended to distinguish technical features, and cannot be construed as indicating or implying relative importance or implicitly indicating a number of the indicated technical features or implicitly indicating a sequence relationship of the indicated technical features.

In the description of the embodiments of the present disclosure, unless otherwise explicitly defined, the words such as “arrange”, “mount” and “connect” should be understood in a broad sense, and those skilled in the art can reasonably determine the specific meanings of the above words in the embodiments of the present disclosure with reference to the specific contents of the technical solutions.

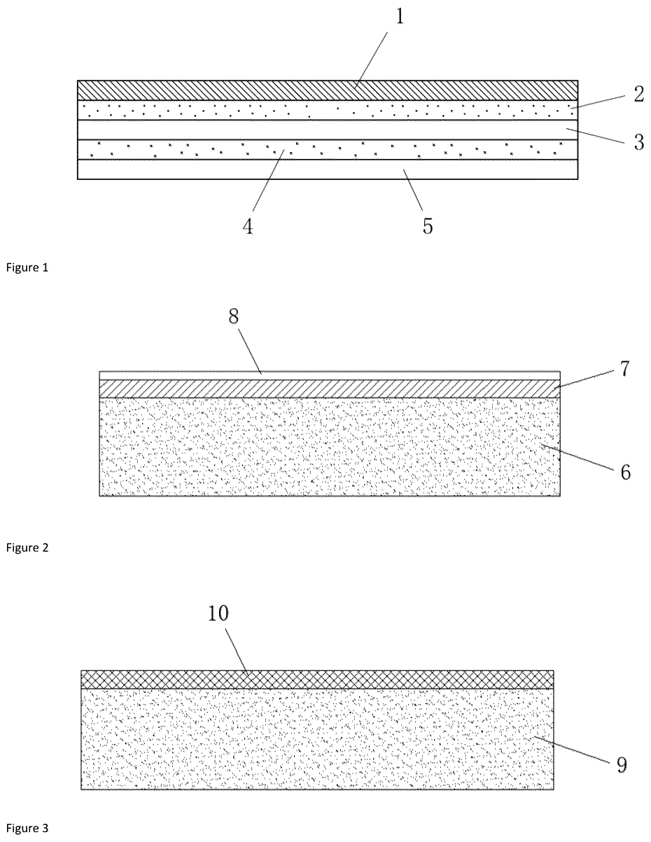

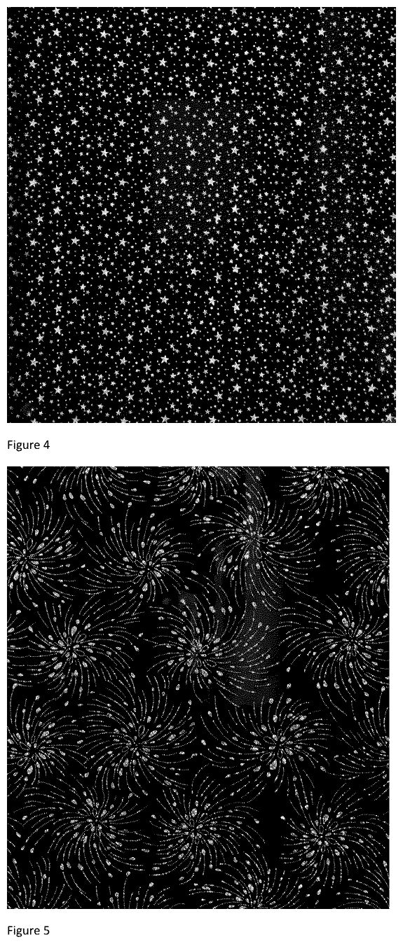

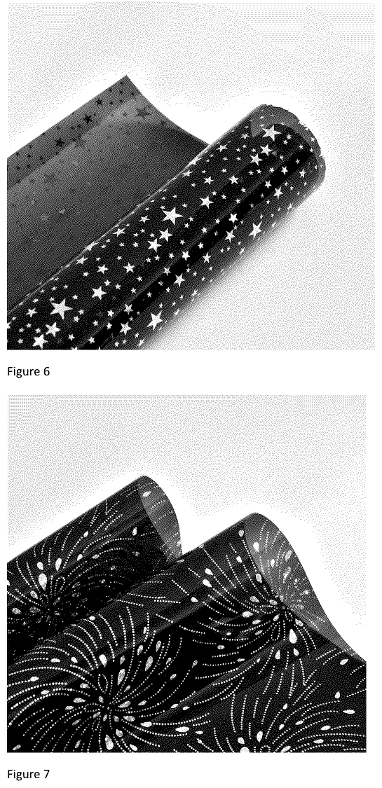

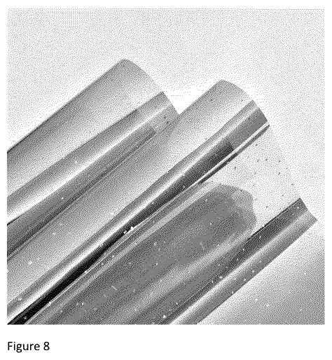

Referring to FIGS. 1 to 8, a preferred embodiment of a flexible laser glass film structure in the embodiments of the present disclosure includes a hardened scratch-resistant transparent layer 1, an ultraviolet- and infrared-resistant transparent layer 2, a laser film layer 3, a mounting adhesive layer 4 and a release film layer 5 that are connected to one another in sequence. The hardened scratch-resistant transparent layer 1 includes a first transparent substrate layer 6, an aluminum-plated layer 7 and a hardened coating 8. The first transparent substrate layer 6 is connected to the ultraviolet- and infrared-resistant transparent layer 2, the aluminum-plated layer 7 is disposed on a surface of the first transparent substrate layer 6 facing away from the ultraviolet- and infrared-resistant transparent layer 2, and the hardened coating 8 is disposed on a surface of the aluminum-plated layer 7 facing away from the first transparent substrate layer 6. The laser film layer 3 includes a second transparent substrate layer 9 and a laser pattern layer 10. The second transparent substrate layer 9 is connected to the mounting adhesive layer 4, and the laser pattern layer 10 is disposed in an incompletely covering manner on a surface of the second transparent substrate layer 9 facing away from the mounting adhesive layer 4. The flexible laser glass film structure of the embodiments of the present disclosure is provided with the aluminum-plated layer 7, so that after ultraviolet and infrared rays are irradiated onto the aluminum-plated layer 7, the aluminum-plated layer 7 reflects the ultraviolet and infrared rays, reducing the degree of penetration of the ultraviolet and infrared rays, and thus improving the ultraviolet- and infrared-resistant effect of the flexible laser glass film structure of the embodiments of the present disclosure. The flexible laser glass film structure of the embodiments of the present disclosure is provided with the hardened coating 8, so that the degree of surface scratching can be reduced, and the structure is more durable. The flexible laser glass film structure of the embodiments of the present disclosure is provided with the ultraviolet- and infrared-resistant transparent layer 2, so that the ultraviolet- and infrared-resistant effect of the flexible laser glass film structure of the embodiments of the present disclosure is further improved. The flexible laser glass film structure of the embodiments of the present disclosure is provided with the laser pattern layer 10, so that on the one hand, the effect of decreasing some ultraviolet and infrared rays can be provided, and on the other hand, the visual effect of the flexible laser glass film structure in the embodiments of the present disclosure can be improved. The laser pattern layer 10 can be shaped according to actual requirements, and thus the visual effect of the flexible laser glass film structure in the embodiments of the present disclosure is further diversified.

A preferred embodiment of the flexible laser glass film structure in the embodiments of the present disclosure may further have the following additional technical features.

In the embodiment of the present disclosure, the thickness of the hardened scratch-resistant transparent layer 1 is not limited but may be set according to actual requirements, and the thickness of the aluminum-plated layer 7 is not limited but may be set according to actual requirements. In an optional embodiment, the hardened scratch-resistant transparent layer 1 has a thickness of 5 μm-65 μm, the aluminum-plated layer 7 has a thickness of less than 1 μm, and specific parameters within the above ranges may be set for the hardened scratch-resistant transparent layer 1 and the aluminum-plated layer 7 according to actual requirements. By using the above parameters, the flexible laser glass film structure can achieve a better performance effect. In other embodiments, the thickness of the hardened scratch-resistant transparent layer 1 may be other parameters outside the range of 5 μm-65 μm, and the thickness of the aluminum-plated layer 7 may be other parameters greater than or equal to 1 μm.

In an optional embodiment, the hardened scratch-resistant transparent layer 1 has a thickness of 23 μm, and the hardened coating 8 has a thickness of 1.5 μm-2 μm. By using the above parameters, the flexible laser glass film structure can achieve an optimal performance effect. In other embodiments, the thickness of the hardened coating 8 may be other parameters outside the range of 1.5 μm-2 μm.

In the embodiments of the present disclosure, the thickness of the laser film layer 3 is not limited but may be set according to actual requirements, and the thickness of the laser pattern layer 10 is not limited but may be set according to actual requirements. In an optional embodiment, the laser film layer 3 has a thickness of 5 μm-60 μm, the laser pattern layer 10 has a thickness of less than 1 μm, and specific parameters within the above ranges may be set for the laser film layer 3 and the laser pattern layer 10 according to actual requirements. By using the above parameters, the flexible laser glass film structure can achieve a better performance effect. In other embodiments, the thickness of the laser film layer 3 may be other parameters outside the range of 5 μm-60 μm, and the thickness of the laser pattern layer 10 may be other parameters greater than or equal to 1 μm.

In an optional embodiment, the laser film layer 3 has a thickness of 23 μm. By using the above parameter, the flexible laser glass film structure can achieve an optimal performance effect.

In the embodiments of the present disclosure, the thickness of the ultraviolet- and infrared-resistant transparent layer 2 is not limited but may be set according to actual requirements. In an optional embodiment, the ultraviolet- and infrared-resistant transparent layer 2 has a thickness of 1 μm-20 μm, and a specific parameter within the above range may be set for the ultraviolet- and infrared-resistant transparent layer 2 according to actual requirements. By using the above parameter, the flexible laser glass film structure can achieve a better performance effect. In other embodiments, the thickness of the ultraviolet- and infrared-resistant transparent layer 2 may be other parameters outside the range of 1 μm-20 μm.

In an optional embodiment, the thickness of the ultraviolet- and infrared-resistant transparent layer 2 is 8 μm. By using the above parameter, the flexible laser glass film structure can achieve an optimal performance effect.

In the embodiments of the present disclosure, the thickness of the mounting adhesive layer 4 is not limited but may be set according to actual requirements. In an optional embodiment, the thickness of the mounting adhesive layer 4 is 1 μm-18 μm, and a specific parameter within the above range may be set for the mounting adhesive layer 4 according to actual requirements. By using the above parameter, the flexible laser glass film structure can achieve a better performance effect. In other embodiments, the thickness of the mounting adhesive layer 4 may be other parameters outside the range of 1 μm-18 μm.

In an optional embodiment, the mounting adhesive layer 4 has a thickness of 7 μm. By using the above parameter, the flexible laser glass film structure can achieve an optimal performance effect.

In an optional embodiment, the ultraviolet- and infrared-resistant transparent layer 2 is a colored adhesive layer. The color of the colored adhesive layer may be set according to actual requirements, so that the visual effect of the flexible laser glass film structure of the embodiments of the present disclosure is further diversified. By adjusting the gradation of color of the colored adhesive layer, the degree of resistance against the ultraviolet and infrared rays can be adjusted, and the requirements of different users can be met. Moreover, the colored adhesive layer can directly bond the hardened scratch-resistant transparent layer 1 to the laser film layer 3, so that the flexible laser glass film structure of the embodiments of the present disclosure is easier to manufacture and has a higher efficiency. In other embodiments, the ultraviolet- and infrared-resistant transparent layer 2 may be other suitable structural layers, and is not limited thereto.

It should be understood that the area of the laser pattern layer 10 covering the surface of the second transparent substrate layer 9 facing away from the mounting adhesive layer 4 will affect light intensity. Therefore, referring to FIGS. 4 and 5, in an optional embodiment, the area of the laser pattern layer 10 covering the surface of the second transparent substrate layer 9 facing away from the mounting adhesive layer 4 is less than the area of the laser pattern layer 10 not covering the surface of the second transparent substrate layer 9 facing away from the mounting adhesive layer 4. By using such a configuration, it can be ensured that the flexible laser glass film structure in the embodiments of the present disclosure can transmit enough intensity of light to meet the use requirements of the users, and improve the user experience. In other embodiments, the area of the laser pattern layer 10 covering the surface of the second transparent substrate layer 9 facing away from the mounting adhesive layer 4 may be equal to the area of the laser pattern layer 10 not covering the surface of the second transparent substrate layer 9 facing away from the mounting adhesive layer 4, or the area of the laser pattern layer 10 covering the surface of the second transparent substrate layer 9 facing away from the mounting adhesive layer 4 may be greater than the area of the laser pattern layer 10 not covering the surface of the second transparent substrate layer 9 facing away from the mounting adhesive layer 4.

In an optional embodiment, the aluminum-plated layer 7 completely covers the surface of the first transparent substrate layer 6 facing away from the ultraviolet- and infrared-resistant transparent layer 2. By using such a configuration, the ultraviolet- and infrared-resistant effect of the flexible laser glass film structure in the embodiments of the present disclosure can be better improved. In other embodiments, the aluminum-plated layer 7 may not completely cover the surface of the first transparent substrate layer 6 facing away from the ultraviolet- and infrared-resistant transparent layer 2.

Those skilled in the art can freely combine and use the above additional technical features provided that no conflict occurs.

The embodiments of the present disclosure further provide a glass, which includes a glass body and a flexible laser glass film structure as described above, the mounting adhesive layer 4 being connected to the glass body after the release film layer 5 is torn off from the flexible laser glass film structure. Since the glass of the embodiments of the present disclosure uses the flexible laser glass film structure of the embodiments of the present disclosure, by providing the aluminum-plated layer 7, after ultraviolet and infrared rays are irradiated onto the aluminum-plated layer 7, the aluminum-plated layer 7 reflects the ultraviolet and infrared rays, reducing the degree of penetration of the ultraviolet and infrared rays, and thus improving the ultraviolet- and infrared-resistant effect of the glass of the embodiments of the present disclosure. By providing the hardened coating 8, the degree of surface scratching can be reduced, and the glass is more durable. By providing the ultraviolet- and infrared-resistant transparent layer 2, the ultraviolet- and infrared-resistant effect of the glass of the embodiments of the present disclosure is further improved. By providing the laser pattern layer 10, on the one hand, the effect of decreasing some ultraviolet and infrared rays can be provided, and on the other hand, the visual effect of the glass in the embodiments of the present disclosure can be improved. The laser pattern layer 10 can be shaped according to actual requirements, and thus the visual effect of the glass in the embodiments of the present disclosure is further diversified.

The embodiments of the present disclosure further provide a window, which includes a window frame and a glass as described above, the glass being disposed on the window frame. Since the window of the embodiments of the present disclosure uses the glass of the embodiments of the present disclosure, by providing the aluminum-plated layer 7, after ultraviolet and infrared rays are irradiated onto the aluminum-plated layer 7, the aluminum-plated layer 7 reflects the ultraviolet and infrared rays, reducing the degree of penetration of the ultraviolet and infrared rays, and thus improving the ultraviolet- and infrared-resistant effect of the window of the embodiments of the present disclosure. By providing the hardened coating 8, the degree of surface scratching can be reduced, and the window is more durable. By providing the ultraviolet- and infrared-resistant transparent layer 2, the ultraviolet- and infrared-resistant effect of the window of the embodiments of the present disclosure is further improved. By providing the laser pattern layer 10, on the one hand, the effect of decreasing some ultraviolet and infrared rays can be provided, and on the other hand, the visual effect of the window in the embodiments of the present disclosure can be improved. The laser pattern layer 10 can be shaped according to actual requirements, and thus the visual effect of the window in the embodiments of the present disclosure is further diversified.

The foregoing implementations are only preferred implementations of the embodiments of the present disclosure and cannot be used to limit the scope of protection of the embodiments of the present disclosure. All non-essential modifications and substitutions made by those skilled in the art on the basis of the embodiments of the present disclosure shall fall within the scope of protection of the embodiments of the present disclosure.

1. A flexible laser glass film structure, comprising: a hardened scratch-resistant transparent layer, an ultraviolet- and infrared-resistant transparent layer, a laser film layer, a mounting adhesive layer and a release film layer that are connected to one another in sequence, wherein
the hardened scratch-resistant transparent layer comprises a first transparent substrate layer, an aluminum-plated layer and a hardened coating, the first transparent substrate layer being connected to the ultraviolet- and infrared-resistant transparent layer, the aluminum-plated layer being disposed on a surface of the first transparent substrate layer facing away from the ultraviolet- and infrared-resistant transparent layer, and the hardened coating being disposed on a surface of the aluminum-plated layer facing away from the first transparent substrate layer; and
the laser film layer comprises a second transparent substrate layer and a laser pattern layer, the second transparent substrate layer being connected to the mounting adhesive layer, and the laser pattern layer being disposed in an incompletely covering manner on a surface of the second transparent substrate layer facing away from the mounting adhesive layer.

2. The flexible laser glass film structure according to claim 1, wherein the hardened scratch-resistant transparent layer has a thickness of 5 μm-65 μm, and the aluminum-plated layer has a thickness of less than 1 μm.

3. The flexible laser glass film structure according to claim 1, wherein the laser film layer has a thickness of 5 μm-60 μm, and the laser pattern layer has a thickness of less than 1 μm.

4. The flexible laser glass film structure according to claim 1, wherein the ultraviolet- and infrared-resistant transparent layer has a thickness of 1 μm-20 μm.

5. The flexible laser glass film structure according to claim 1, wherein the mounting adhesive layer has a thickness of 1 μm-18 μm.

6. The flexible laser glass film structure according to claim 1, wherein the ultraviolet- and infrared-resistant transparent layer is a colored adhesive layer.

7. The flexible laser glass film structure according to claim 1, wherein the area of the laser pattern layer covering the surface of the second transparent substrate layer facing away from the mounting adhesive layer is less than the area of the laser pattern layer not covering the surface of the second transparent substrate layer facing away from the mounting adhesive layer.

8. The flexible laser glass film structure according to claim 1, wherein the aluminum-plated layer completely covers the surface of the first transparent substrate layer facing away from the ultraviolet- and infrared-resistant transparent layer.

9. A glass, comprising: a glass body and a flexible laser glass film structure, a mounting adhesive layer being connected to the glass body after a release film layer is torn off from the flexible laser glass film structure;
wherein the flexible laser glass film structure comprises a hardened scratch-resistant transparent layer, an ultraviolet- and infrared-resistant transparent layer, a laser film layer, the mounting adhesive layer and the release film layer that are connected to one another in sequence;
the hardened scratch-resistant transparent layer comprises a first transparent substrate layer, an aluminum-plated layer and a hardened coating, the first transparent substrate layer being connected to the ultraviolet- and infrared-resistant transparent layer, the aluminum-plated layer being disposed on a surface of the first transparent substrate layer facing away from the ultraviolet- and infrared-resistant transparent layer, and the hardened coating being disposed on a surface of the aluminum-plated layer facing away from the first transparent substrate layer; and
the laser film layer comprises a second transparent substrate layer and a laser pattern layer, the second transparent substrate layer being connected to the mounting adhesive layer, and the laser pattern layer being disposed in an incompletely covering manner on a surface of the second transparent substrate layer facing away from the mounting adhesive layer.

10. A window, comprising: a window frame and a glass, the glass being disposed on the window frame, wherein the glass comprises a glass body and a flexible laser glass film structure, a mounting adhesive layer being connected to the glass body after a release film layer is torn off from the flexible laser glass film structure;
wherein the flexible laser glass film structure comprises a hardened scratch-resistant transparent layer, an ultraviolet- and infrared-resistant transparent layer, a laser film layer, the mounting adhesive layer and the release film layer that are connected to one another in sequence;
the hardened scratch-resistant transparent layer comprises a first transparent substrate layer, an aluminum-plated layer and a hardened coating, the first transparent substrate layer being connected to the ultraviolet- and infrared-resistant transparent layer, the aluminum-plated layer being disposed on a surface of the first transparent substrate layer facing away from the ultraviolet- and infrared-resistant transparent layer, and the hardened coating being disposed on a surface of the aluminum-plated layer facing away from the first transparent substrate layer; and
the laser film layer comprises a second transparent substrate layer and a laser pattern layer, the second transparent substrate layer being connected to the mounting adhesive layer, and the laser pattern layer being disposed in an incompletely covering manner on a surface of the second transparent substrate layer facing away from the mounting adhesive layer.
